(19) United States
(12) Patent Application Publication
(10) Pub. No.: US 2009/0134346 A1
(43) Pub. Date: May 28, 2009

(54) CONTAINER AND METHOD AND DEVICE FOR MANUFACTURING OF SUCH CONTAINERS

(76) Inventors: Hallvar Eide, Orskog (NO); Rune Godoy, Sandnes (NO)

Correspondence Address: DENNISON, SCHULTZ & MACDONALD, 1727 KING STREET, SUITE 105, ALEXANDRIA, VA, 22314, US

(21) Appl. No.: 12/064,724

(22) PCT Filed: Sep. 7, 2006
(86) PCT No.: PCT/NO06/00310

§ 371 Date: Jun. 19, 2008

(30) Foreign Application Priority Data
Sep. 7, 2005 (NO) 20054161

(51) Int. Cl. G21F 5/00

(52) U.S. Cl. 250/506.1

(57) ABSTRACT

Container for storing environmental dangerous materials, particularly for lasting deposit of nuclear waste material. The container is cast of a mineral material, particularly concrete. The container has a restricted opening (12) provided for inserting a closing plug (34). The container is prepared as an integral element without material transitions or seams. It has recesses or knobs (16) in the inner wall.

The invention relates to a container as stated in the introductory part of claim 1, particularly a container for waste material which is to be deposited for an extended period under safe conditions, unaffected by climatical and other influences. It also relates to a method and a device for manufacturing such containers.

### BACKGROUND

A container with particular superior properties is needed for lasting storage of dangerous waste material, e.g. nuclear waste material. Such containers may be manufactured of different casting material, e.g. concrete with or without aggregates. The casting of such containers, which should be extremely tight and extremely mechanically sturdy, has been a difficult challenge in respect of mould making and casting process.

Known containers of concrete, have, due to the inner mould, been manufactured in two or more parts which are joined after curing. Such joined moulded containers have not been suitable for the containment of nuclear waste material, due to their being of uncertain longevity.

For containers with a main part in one piece, a relatively wide filling opening is provided, for removing inner casting elements.

No industrial prior art methods for manufacturing of such containers have been satisfactory.

From Belgian Patent Specification 699460 (Van Hove, 1967) it is known to use an inflated “balloon” as a core for manufacturing a hollow body. Such a core will not be suitable for casting of a material of high density, such as concrete.

From EP-patent specification 0040579 (Arbed 1981) it is known to cover a balloon shaped mould with a layer of concrete to provide a bottle shaped container. This has not been suitable for a waste material container with the strength and longevity properties required for this purpose.

From French patent specification 2.631.278 (Leviel 1989) it is known to fill the void between inflated sack structures with a granular material, for providing a container with an arbitrary shape. This method also does not allow the manufacture of a sturdy waste material container.

From U.S. Pat. No. 2,517,905 (Luebkeman, 1950) it is known to prepare inner casting moulds for casting voids by using a granular material which is pressed to the desired form in a flexible sack under high pressure and which after curing of the added casting material is dissolved and poured from the finished cast object. Such moulds can not be used for containers in the size range considered in this case, from 100 to 1000 dm³.

From British patent specification 1589871 (Conder Group 1981) it is known to cast a concrete tank in a void in the ground with an inner mould provided as a pressurized sack of rubber. This requires a cast base onto which the inner mould can rest, and precautions are required to prevent the air filled rubber sack from floating in the flowable casting material. It is difficult to combine the strength requirements for heavy inner pressurizing with the thin wall thickness which is needed for reclaiming the inner mould through a narrow opening.

In spite of several efforts for designing an inner casting form with flexible sacks, it has not been possible to find a solution suitable for manufacturing of waste material containers of a certain size and with stringent property requirements.

### OBJECT

The main object of the invention is to provide a container which is more suitable than prior art containers for extended storage of dangerous waste material, as well as a method and a device for manufacturing such containers. It is particular important to provide a container with particular longevity and particular mechanical strength and density. A container is desired, which can accommodate waste material over a very long period, preferably several hundred years.

More specifically, it is an important object to provide a container and a method for its manufacture enabling the casting in one piece and with a narrow opening. The container and the method should be suitable for casting of concrete, with or without aggregates, and should provide container walls without seams or transitions risking leakage.

It is also an object to provide a container which can be closed safely and without leakage, with longevity also in the closure.

A further object is to provide a device suitable for manufacturing such containers.

### THE INVENTION

The invention is stated in the claims, claim 1 defining a container, claim 8 a method for manufacturing such containers and claim 13 a device for carrying out said method.

The novel container has advantages in use and provides for efficient manufacturing. It will particularly provide tightness and longevity when manufactured using a concrete containing the mineral aplite.

With the method according to the invention it will be possible to manufacture industrially the novel container of concrete and similar casting material, particularly for the purpose of storing environmental hazardous material and waste. The method according to the invention will enable the provision of the opening with threads integrated in the moulded material. This will make a safe and lasting closure of the container possible, with material integration between the container and the closing element. This achievement is novel.

The proposed device for carrying out this method provides for efficient manufacture with a one piece moulding, with low mould expenses.

The dependent claims define stating particular preferred features of the invention. Further details will be described in the following example.

### EXAMPLE

The invention is described with reference to the drawings, wherein

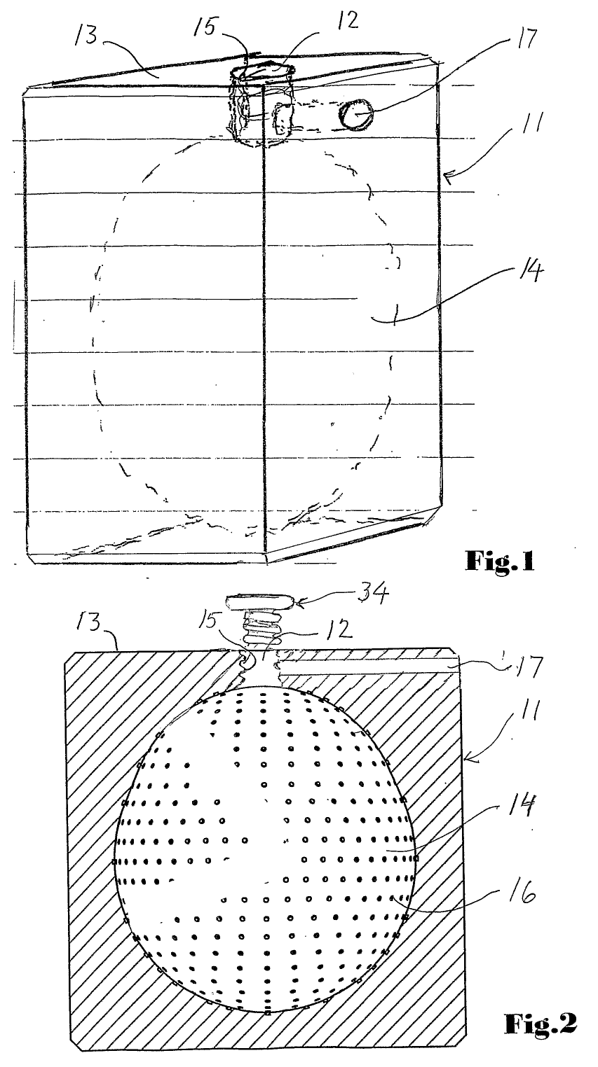

FIG. 1 shows a perspective view of an embodiment of a waste material container according to the invention, wherein the inner part is shown by ghost lines,

FIG. 2 shows a vertical section of the container of FIG. 1,

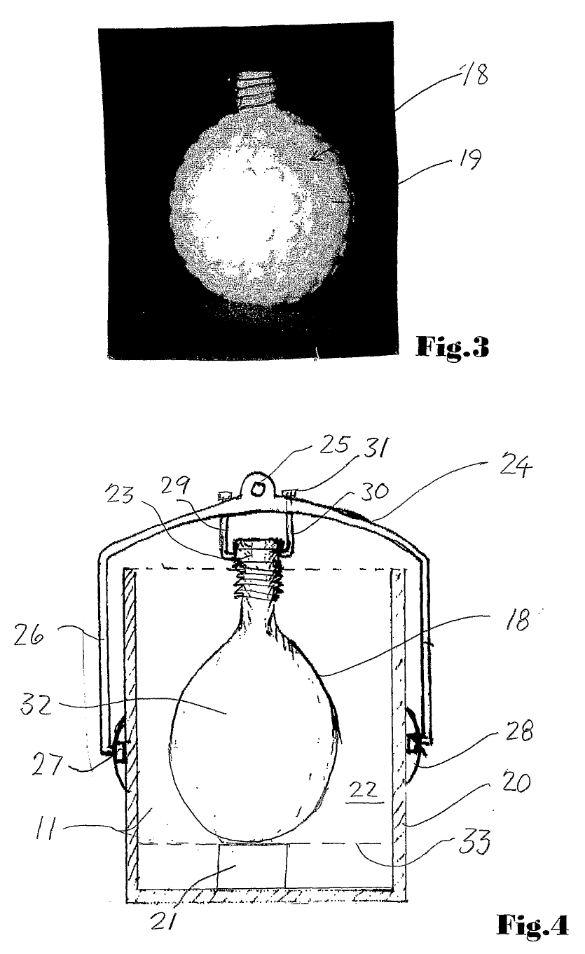

FIG. 3 shows a side view of an inner mould suitable for manufacturing the waste material container of FIGS. 1 and 2, and

FIG. 4 shows a vertical section of the inner and the outer mould ready for casting.

FIGS. 1 and 2 show an example of an embodiment of a moulded waste material container 11 according to the invention. The waste material container 11 has a cubical outer shape with an inlet opening 12 centrally in the upper face 13. The inner void 14 of the waste material container 11 of the example is egg shaped with a vertical main axis. The inlet opening 12 has threads 15 in the surrounding wall, for entering of a closing plug (not shown). Further, the waste material container 11 may have lifting elements inserted as shown in FIG. 4, although it is possible to handle a filled waste material container with a forklift or similar equipment.

The waste material container 11 of the example has a pattern of recesses 16 in the inner wall, for increasing the adhesion between the filled waste material and the container wall. The material for the container can be any suitable casting mass curing with the strength necessary and with a service life suitable for the storage need. Further, requirements may be presented in respect of attenuation of radiation, impact resistance, diffusion density and other qualities.

Transverse to the inlet opening 12 is arranged a passage 17 for venting when filling. The passage or breather 17 of the example has threads, to allow for the inserting of a plug of the material of the waste material container. Below is a description of the preparation of the mould for creating the passage 17.

The closing plug of the waste material container is indicated by reference numeral 34.

In FIG. 3 is shown an inner part 18 for the preparation of the waste material container 11 of FIGS. 1 and 2. The inner part 18 of the mould is prepared on the base of a mould body or “plug” with a design and surface structure corresponding to the final inner wall and the opening 12 of the waste material container 11.

The plug can be according to prior art with respect to material and processing and being suspended to be accessible from all sides. It is covered by a flowable material which is cured to an elastic substance, e.g. silicone. After curing, this cover layer is pulled off in reverse, to provide an inner mould part or inner mould 18 as shown in FIG. 3.

In an alternative embodiment, a female part corresponding to the inner side of the container is prepared, which is then used for rotational moulding with a curable, elastic substance. After curing, this “sack” 18 is then removed from the female part and is used as the inner mould. It then will have a surface with knobs 19 in an even pattern for providing recesses 16 (FIG. 2). Alternatively, the inner mould may 18 may have recesses for providing knobs in the final container wall.

In FIG. 4, a section through a complete mould for casting of a waste material container 11 according to the invention is shown. A box shaped outer mould 20 with an upper opening for filling with casting substance is arranged. In the outer mould 20, an inner mould 18 as described above is arranged, to leave a void at all sides. Under the inner mould 18, a supporting block 21 of the same material as for the container to be moulded is arranged, which block will thus be closely integrated with the material entered into the void 22 between said two moulds 18 and 20.

The inner mould 18 is suspended from an annular collar 23 enclosing the upper end of the inner mould. The collar 23 is connected to a supporting yoke 24 extending over the mould assembly and which has a lifting hook 25 and a pair of descending arms 26 with a grip element 27 at the lower end. The grip elements 27 are able to be entered into a releasable and pivotal engagement with a pair of gripping brackets 28 on the outer mould 20. The gripping brackets 28 of the example are arranged close to a horizontal axis through the center of gravity of the mould assembly, for turning the mould assembly, e.g. for emptying the filler from the inner mould 18 after curing. The use of this filler will be described in the following.

The collar 23 is connected to the yoke 24 by a pair of bolts 29, 30, each with a nut 31 on the upper side of the yoke 24 adjoining the lifting hook.

To provide the air passage 17, a rubber plug on a support rod supported by the outer mould 20 is inserted into the mould.

To maintain the inner mould 18 open during casting, it is filled with a flowable filler material 32 with sufficient specific density.

By filling a bottom layer 33 in the outer mould 20, and then filling the outer mould 20 with casting material and the inner mould 18 parallel with flowable filler material 32, there will be a balance in buoyancy and weight for the inner mould 18, to reduce the load at its suspension considerably.

As flowable filler material 32, various qualities of a fluid or granular material is poured into and out of the inner mould 18.

After curing the casting material of the waste material container 11, the inner mould 18 is emptied for filler material 32, e.g. by turning the mould assembly around an axis (not shown) to an emptying position, or by suction. The elastic inner mould 18 is then withdrawn from the waste material container 11 and prepared for the moulding of another container.

A casting material suitable for use is concrete with or without aggregate e.g. manganese tetraoxide (MnSO4) can be used which are dust particles from smelting plants and which can be spherical. It is particularly advantageous when aplite is added to the concrete. This increases the strength, density and longevity.

As reinforcement carbon fibres can be distributed in the casting material when poured into the mould. Other kinds of reinforcement may also be used, when compatible with the requirements for strength and longevity.

The design of the outer mould can deviate from cubical design shown, other parallel epical designs, cylindrical, bottle design or carboy design may be used.

The container according to the invention can be used for multiple purposes, wherein a demanding material is to be stored and/or transported, e.g. as a part of a production process, such as chemically aggressive substances, or corresponding waste materials.

The container according to the invention may also be a layered structure, with a cover of another material, to make the container more suitable for handling and stacking for storage.

1. Container for storing environmentally dangerous materials, particularly for deposit of nuclear waste material, where at least the inner part of the container is cast from a mineral material, particularly concrete, and where the container (11) has a restricted opening (12) provided for inserting a closing plug (34),
at least the inner wall of the container being prepared as an integral element without material transitions or seams, and at least the inner part of the container being cast from a material comprising aplite.

2. (canceled)

3. Container according to claim 1, wherein the container comprises an inner void (14) which is generally spherical, particularly egg shaped or drop shaped, with a vertical main axis.

4. Container according to claim 1, wherein the opening has threads (15) for insertion of a mating plug (34).

5. Container according to claim 1, wherein the wall of the void has a wafer design or a pattern of recesses (16), to increase the surface.

6-7. (canceled)

8. Method for manufacturing a container of a cast material, particularly for deposit of a contaminating material, including nuclear waste material, with a void being accessible through a restricted opening, whereby a sack of flexible material which is suspended in an outer mould during pouring and curing, is used as the inner mould, which after the curing preferably is withdrawn from the void of the finished container, characterized in that the inner mould during the pouring of the casting material in the outer mould is fed with a flowable filler material with a specific density being insignificantly lower than that of the casting material.

9. Method according to claim 8, wherein the emptying of the inner mould is conducted by suction.

10-11. (canceled)

12. Method according to claim 8, wherein the inner mould is a sack prepared by covering a mould plug with a curing, elastic material, particularly silicone rubber.

13. (canceled)
